(19) United States
(12) Patent Application Publication
(10) Pub. No.: US 2006/0253395 A1
(43) Pub. Date: Nov. 9, 2006

(54) Format and systems for secure utilization of electronic fonts

(75) Inventor: Christopher A. Corbell, Portland, OR (US)

Correspondence Address: BANNER & WITCOFF, LTD., 1001 G STREET, N.W., WASHINGTON, DC, 20001-4597, US

(73) Assignee: Extensis Corporation, Portland, OR (US)

(21) Appl. No.: 11/354,623

(22) Filed: Feb. 14, 2006

Related U.S. Application Data
(60) Provisional application No. 60/653,063, filed on Feb. 14, 2005.

(51) Int. Cl. G06Q 99/00

(52) U.S. Cl. 705/50

(57) ABSTRACT

A font archive includes encrypted font data and metadata. The metadata may include a variety of information associated with the font data, such as customer-specific information for a customer that has purchased a license to use the font data. The metadata may include license information associated with the font data, such as license terms under which the font data may be previewed or used. Still further, the metadata may include preview information that allows the font to be previewed without obtaining a license to the font. The font data typically can only be decrypted for activation by an authorized font archive handler application. The font archive handler application then controls the use of the decrypted font data to ensure that it complies with the license information contained in the metadata. The font archive handler application also ensures that the decrypted font data is not stored on a disc drive or other non-volatile storage medium, to prevent it from being improperly copied for use outside of the font data license.

### RELATED APPLICATIONS

This application claims priority to U.S. Provisional Patent Application No. 60/653,063, entitled “Archive Format And Systems For Secure Network-Distributed Utilization Of Proprietary Electronic Fonts,” filed on Feb. 14, 2005, and naming Christopher Corbell as inventor, which provisional patent application is incorporated entirely herein by reference.

### FIELD OF THE INVENTION

The present invention relates to electronic fonts. More particularly, various aspects of the invention relate to formats for securely using electronic fonts that are distributed, for example, through a network.

### BACKGROUND OF THE INVENTION

There is an increasing need in commercial print and media production environments to distribute electronic fonts among multiple computer systems. By sharing fonts among multiple computer systems, a commercial printer or media producer can ensure that a desired font is available for use on a particular computer when needed, without having to maintain a copy of the font on each computer system. While it is technically trivial with current systems to share fonts across networks and deploy fonts for rendering of Internet content, many fonts are proprietary. Thus, indiscriminately sharing fonts among multiple computer systems will often violate the license terms of commercial foundries that have produced the fonts. Accordingly, it would be desirable to have a general-purpose, secure distributed usage scheme for font data that can allow users to distribute proprietary fonts among multiple computer systems while maintaining any license terms for the fonts. Further, it would be desirable for the secure distributed usage scheme to be compatible with major font foundries and vendors.

### BRIEF SUMMARY OF THE INVENTION

Various aspects of the invention relate to an encrypted archive format to protect font data by facilitating enforcement license terms set by the authoring foundry, permitting secure online browsing of and purchasing of fonts, and allowing secure site-specific deployment of properly licensed fonts over the Internet for rendering of online content. According to some implementations of the invention, a font archive includes encrypted font data and metadata. The metadata may include a variety of information associated with the font data, such as customer-specific information for a customer that has purchased a license to use the font data. The metadata may include license information associated with the font data, such as license terms under which the font data may be previewed or used. Still further, the metadata may include preview information that allows the font to be previewed without obtaining a license to the font.

While the font archive can be transferred to a computer, the font data typically can only be decrypted for activation by an authorized font archive handler application. The font archive handler application then controls the use of the decrypted font data to ensure that it complies with the license information contained in the metadata. The font archive handler application also ensures that the decrypted font data is not stored on a disc drive or other non-volatile storage medium, to prevent it from being improperly copied for use outside of the font data license.

### BRIEF DESCRIPTION OF THE DRAWINGS

FIG. 1 illustrates one example of a general purpose computer that may be employed to implement or use a font format according to various embodiments of the invention.

FIG. 2 illustrates an example of a font archive data structure that may be employed to archive font data according to various embodiments of the invention.

FIG. 3 illustrates components of a commerce system that can employ the font archive data structure according to various examples of the invention.

FIGS. 4A-4C illustrate a flowchart describing a method of previewing bitmaps for a font according to various embodiments of the invention.

FIGS. 5A-5E illustrates a flowchart describing a method of previewing select glyphs of a font according to various embodiments of the invention.

FIGS. 6A-6D illustrate a flowchart describing a method of purchasing licensed font data according to various embodiments of the invention.

FIG. 7 illustrates the components of client system that can activate and use font data according to various embodiments of the invention.

FIGS. 8A-8D illustrate a flowchart describing a method of activating licensed font data according to various embodiments of the invention.

### DETAILED DESCRIPTION OF THE INVENTION

Example Computer

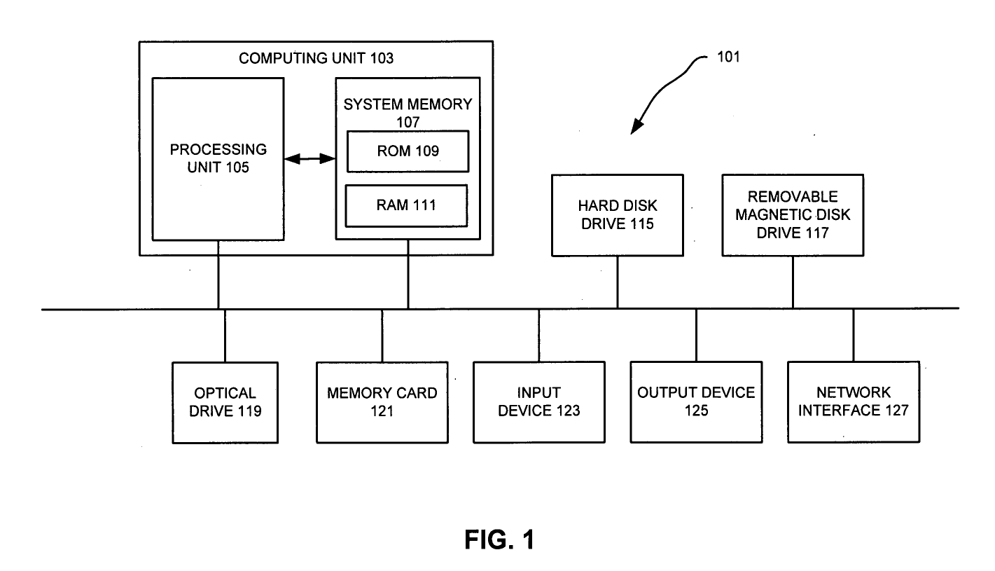

As will be discussed in more detail below, various aspects of the invention may be implemented by a data structure maintained on a programmable computing device or computer, or by executing software instructions on a computer. FIG. 1 thus shows an example of a computer 101 that can be used to implement various examples of the invention.

The computer system 101 illustrated in FIG. 1 includes a processing unit 103, a system memory 105, and a system bus 107 that couples various system components, including the system memory 105, to the processing unit 103. The system memory 105 may include a read-only memory (ROM) 109 and a random access memory (RAM) 111.

The computer 101 may also include one or more memory storage devices 113, input devices 115, and output devices 117. Thus, as shown in FIG. 1, the computer 101 may include a magnetic hard disk drive 113A, an optical disk drive 113B or both. The input devices 115 employed by the computer 101 may then vary depending upon the intended use of the computer 101. For example, if the computer 101 is intended primarily to host and execute video game software, then the computer 101 may have a joystick console 115A or similar human interface control suitable for gaming. If, however, the computer 101 is intended to operate as a general purpose personal computer (e.g., a conventional desktop or laptop computer), then it may alternately or additionally have a keyboard 115B.

Similarly, the output devices 117 employed by the computer 101 may also vary depending upon the intended use of the computer 101. Typically, most variations of the computer 101 will have a display monitor 117A. If the computer 101 is configured to operate as a general purpose personal computer, then it may alternately or additionally have a printer. Still other memory storage devices 113, input devices 115 and output devices 117 may include “punch” type memory (where physical indentations are made in the memory medium), holographic memory devices, pressure detectors, cameras, scanners, microphones, and vibration or other motive feedback devices.

As shown in FIG. 1, the computer 101 additionally has a device interface 119. This device interface 119 may be any type of interface used to obtain data from another device. For example, the device interface 119 may be a conventional connector/port type interface, such as universal serial bus (USB) interface, a Firewire/IEEE 1394 interface, a PS/2 interface, a PC/AT interface, an RS-232 interface, a serial port interface, or an Ethernet port or other telephone-type interface. As will be appreciated by those of ordinary skill in the art, some connector/port type interfaces may have a variety of different configurations. For example, a USB interface may be a USB 1.1 interface or a USB 2.0 interface. It also may be a standard USB interface, a mini USB interface, or a micro USB interface. Accordingly, the device interface 119 may be any type of connector/port type interface of any desired configuration.

Still further, the device interface 119 may include a wireless transceiver for wireless communication with another device. For example, the device interface 119 may be implemented with a radio frequency transceiver, such as a WiFi or Bluetooth wireless transceiver. The device interface 119 may alternately be implemented with an infrared frequency transceiver, a light frequency transceiver, or an ultrasonic frequency transceiver. The device interface 119 may be an internal interface, or it may alternately be an external network interface as is well known in the art. Of course, it will be appreciated that other means of establishing a communications link with other computers may be used.

Typically, the computer 101 will be configured to access one more other computing devices, so that a consumer can employ the computer 101 to custom-order an article through another computing device maintained by a retailer. Thus, the computer 101 will normally be capable of operating in a networked environment using logical connections to one or more remote devices, such as other computers. The computer 101 may be connectable to one or more remote devices through a local area network (LAN) or a wide area network (WAN), such as the Internet. When used in a networking environment, the computer system 101 may be connected to the network through the device interface 119.

Font Archive Data Structure

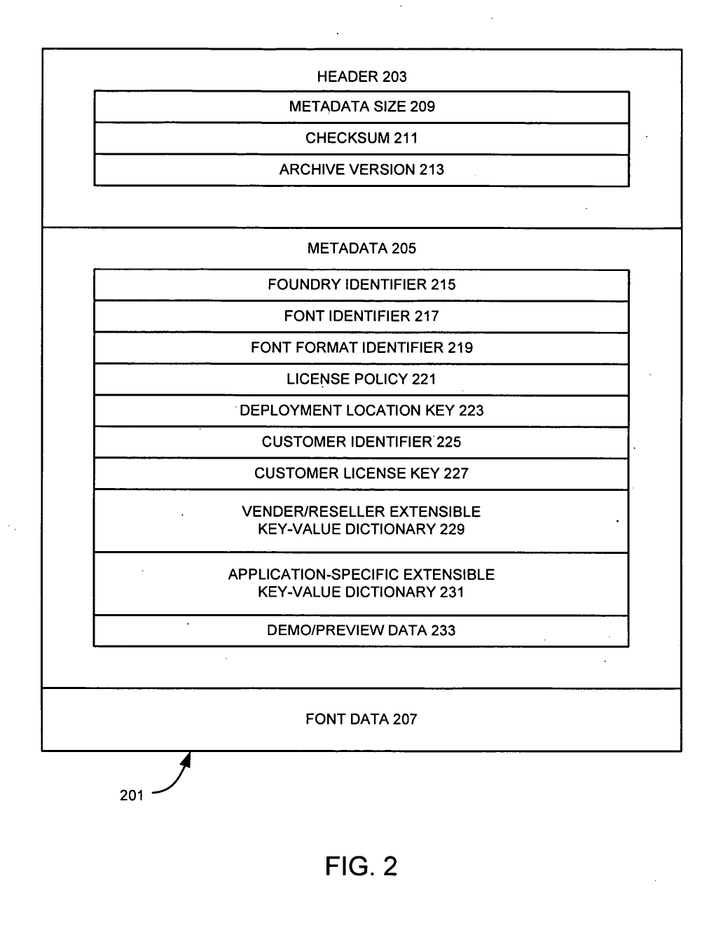

FIG. 2 illustrates an example of a font archive data structure 201 that can be employed as a font archive to archive, distribute, and use fonts, such as proprietary fonts. As will be discussed in more detail below, the archive data structure 201 is a binary file format which contains both encrypted font data and metadata. According to various examples of the invention, computing systems can employ this data structure 201 to transfer both font data and related metadata securely between software applications in a network environment. Moreover, various examples of the invention allow a user to preview proprietary font data without violating a license for the font data.

With various examples of the invention, font archive data structure 201 may be a contiguous sequence of binary data. As illustrated in FIG. 2, the font archive data structure 201 includes three separate data segments: a header 203, metadata 205, and font data 207. With some examples of the invention, each of these segments 203-207 may be encrypted together. With still other embodiments of the invention, however, these three segments, although contiguous, are separately encrypted. Separate encryption (and thus separate decryption) permits optimization in decrypting and handling the metadata 205 for license verification, particularly when the font data is relatively large. It should be appreciated that any desired encryption method can be used to encrypt the three data segments. For example, the Digital Signature Algorithm (DSA) may be used with some embodiments of the invention to encrypt one or more of the data segments 203-207.

Typically, the header 203 will be a fixed encrypted size. As will be discussed in more detail below, the header 203 normally will be decrypted first, to determine the encrypted sizes of the segments which follow in the font archive data structure 201. The header 203 may contain any desired information relating to the metadata 205 and font data 207. For example, with some embodiments of the invention, the information in the header 203, when decrypted, may include three integers indicating the size 209 (in, e.g., bytes) of the encrypted metadata 205, a checksum 211 generated from the contiguous, encrypted metadata 205 and font data 207 segments of the font archive, and the version 213 of the font archive format being used.

Thus, before decrypting the metadata 205, a client computer can check the metadata size 209 to confirm that it has sufficient resources available to complete the decryption process. Also, the client computer can use the checksum 211 to confirm that the metadata 205 and font data 207 have not been corrupted. The version 223 can then be used to determine the specific fields of information contained in the metadata 205 and/or the font data 207. Of course, as previously noted, various examples of the invention may include additional or alternate information in the header 203 relating to the metadata 205 or font data 207. Further, some embodiments of the invention may omit one or more of the metadata size 209, the checksum 211, and the archive version 212 from the header 203.

The metadata 205, when decrypted, may include any desired information supplemental or otherwise relating to the font data 207. Thus, the metadata 205 may include data that permits a user to identify the font defined by the font data 207, its foundry, data relating to license validation and deployment enforcement by the software expected to handle the font archive data structure 201, and any desired extensible additional data to facilitate usability of the font data 207 by users or other potential purchasers of the font.

For example, as illustrated in FIG. 2, the metadata 205 may include a foundry identifier 215. The foundry identifier 215 may be a string uniquely identifying the manufacturer of the font. The metadata 205 may also include a font identifier 217, which may be a dictionary identifying the font. Typically, the font identifier 217 will include the font name, and may optionally include the font version and a foundry-specific identifier, such as a product code. Still further, the metadata 205 may include a font-format identifier 219, which may be, e.g., a dictionary which declares the format of the unencrypted electronic font data 207. The font-format identifier 219 may also include a string identifier that identifies the format and a version for the font format, if applicable.

The metadata 205 may further include a license policy 221. The license policy 221 may be one of a set of values which indicate the deployment and usage (i.e., activation) permissions associated with the license for the purchase or other use of the font data 207. The foundry and/or vendor of the font data 207 may dictate the license policy. It should be appreciated that the same font data 207 may be packaged in multiple instances of the font archive data structure 201 which differ only by the values of the license policy (e.g., where each font archive data structure 201 corresponds to a different licensing policy). Multiple policies may be combined when desire. For example, multiple licensing policies may be combined to represent the combination of different activation policy restrictions. For example, the license policy 221 may contain a value identifying any of the following types of policies:
unrestricted—A font user may activate the font data 207 on any computer, through any activation means.
no-web—A web “plug-in” which handles font activation will not activate this font when embedded in hypertext for rendering content in a browser.
registered—A font user may activate the font data 207 on a computer or in another context where the font is registered, i.e., validated against registration data stored external to the font archive data structure 201.
application—A font user may activate the font data 207 only if it is being activated by a specific software application.
document—A font user may activate the font data 207 only if it is being activated for a named document. If a software application is also specified, the document must be in use by the indicated application. If registration also is specified, the registration information may (but need not) be stored in the target document.
expiring lease—In addition to any other specified license policy value, this value indicates that the license will expire after a set time period.
web only—The font data 207 may only be activated by a web browser “plug-in” for rendering of hypertext.
web deployment—The font data 207 may only be activated by a web browser “plug-in,” and only if the document embedding the font data 207 is located in a specified domain or below a specified URL.
demo—The font data 207 may only be activated for demonstration purposes in an authorized e-commerce browser application. The font data 207 may not be activated globally on the client computer system.
bitmap only—The font data 207 may not be activated, but its static preview bitmaps (discussed in more detail below) may be displayed.
glyph-suppressed—The font data 207 may only be activated after some of its glyphs have been suppressed by the font archive handler (discussed in more detail below).

It should be appreciated that, while the preceding policies have been discussed, these policies are examples and are not intended to be limiting. For example, the license policy may include other specific customer license terms relating to license duration and/or deployment restrictions, to control activation of the font data 207. Also, the license policy 221 of various embodiments of the font archive data structure 201 may include information for any type of font license according to the needs of font foundries, font vendors, and their customers.

Returning now to FIG. 2, the font archive data structure 201 may also include a deployment location key 223, which may be a list of Uniform Resource Identifier (URI) strings. The interpretation of the URI strings will vary according to license type, but in most cases they will represent the legal locations where the font data 207 can reside in order to be used. For example, a URI string may specify that that font data 207 may be activated by a font archive handler for use on a specific host computer system. If the font data 207 is licensed for a particular software application or document, then the URI strings will use special extensions to the standard URI formats to indicate this restriction, such as “application:// . . . ” and “document:// . . . ”.

The font archive data structure 201 may also include a customer identifier 225, which may be a dictionary of identifying information for a customer. The customer identifier 225 may include, for example, the customer name and a customer identification value generated by the vendor of the font data 207. It may also contain any desired additional information, such as a customer e-mail address and a company name.

Still further, the font archive data structure 201 may include a customer license key 227. The customer license key 227 may be a unique license key generated for a particular customer by the vendor of the font data 207. The validation scheme of this license key will typically vary by license type and vendor. With various examples of the invention, a font archive handler will interpret this key based on the license type and established (though not necessarily public) algorithms. For example, if an external license key is required to be present on the computer that will host the font data 207, this key may correspond to one half of a DSA key pair. The other half of the DSA key pair must then be installed on the host computer for the font data 207 to be activated.

The font archive data structure 201 may also include an extensible key-value dictionary 229. This extensible key-value dictionary 229 is provided for vendor/resellers to insert additional information into the font archive data structure 201, in order to facilitate commerce and support of the font data 207. Thus, the extensible key-value dictionary 229 may include information such as a vendor-specific transaction identification value for the purchase of the font data 207, a serial number of a published CD containing the font archive data structure 201, or any other information desired by the vendor/reseller of the font data 207.

The font archive data structure 201 additionally may include an extensible key-value dictionary 231 for application-specific metadata. This application-specific metadata may include any information designed to enrich end-user experience in font management applications, such as information for absolute unique identification and matching of the font, style information, and other data not directly obtainable from the font data 207 itself.

With some examples of the invention, the font archive data structure 201 also will include demo/preview data 233. The demo/preview data 223 enables trial use or online previewing of at least a portion of the font data 207 before it is licensed. For example, the demo/preview data 223 may contain two sections: a glyph suppression table and a dictionary of preview bitmaps. The glyph suppression table identifies some glyphs in the font data 207 that should not be rendered until after the font data 207 has been properly licensed. As previously noted, the font archive handler manages the use of the font archive data structure 201 on a client computer system. Thus, the font archive handler will be configured to nullify the representation of these glyphs in the client computer's random access memory (RAM) before allowing the font data 207 to be activated. The identified glyphs instead may be rendered as, for example, undefined characters. The bitmap dictionary is a list of bitmaps of the font rendered at screen resolution. The keys of the bitmap dictionary indicate the type of preview available, such as “Alphabet”, “Waterfall” or “Paragraph”. Of course, it should be appreciated that, with alternate embodiments of the font archive data structure 201, the demo/preview data 223 may include only one of the glyph suppression table and the dictionary of preview bitmaps.

Returning now to FIG. 2, the font data 207 will be data describing the original font created by the font foundry. Advantageously, various implementations of the font archive data structure 201 will not require any particular format for this data. Typically, however, this font data 207 will be representable as a single contiguous chunk of binary data which can be activated “in-memory” (i.e., in the RAM of the client computer system) by the font archive handler. For example, the font data 207 may be in a TrueType™ or OpenType™ font format, or any other desired font format. Further, the font archive data structure 201 may be extended to support any desired font data. As will be discussed in more detail below, however, supported font data 207 should permit major operating systems to activate the font data 207 securely in-memory rather than from a decrypted archive on a non-volatile accessible storage medium, such as a hard disk drive, optical storage drive, memory card or the like.

As will also be explained in more detail below, an electronic commerce system may use the font archive data structure 201 according to various examples of the invention to permit customers to browse and preview available fonts, and then download these fonts securely with license terms set by an e-commerce server at purchase-time. Moreover, the font data 207 in the font archive data structure 201 can remain strongly encrypted both on the online e-commerce server and when downloaded to the customer's machine, to prevent font piracy.

Font Commerce System

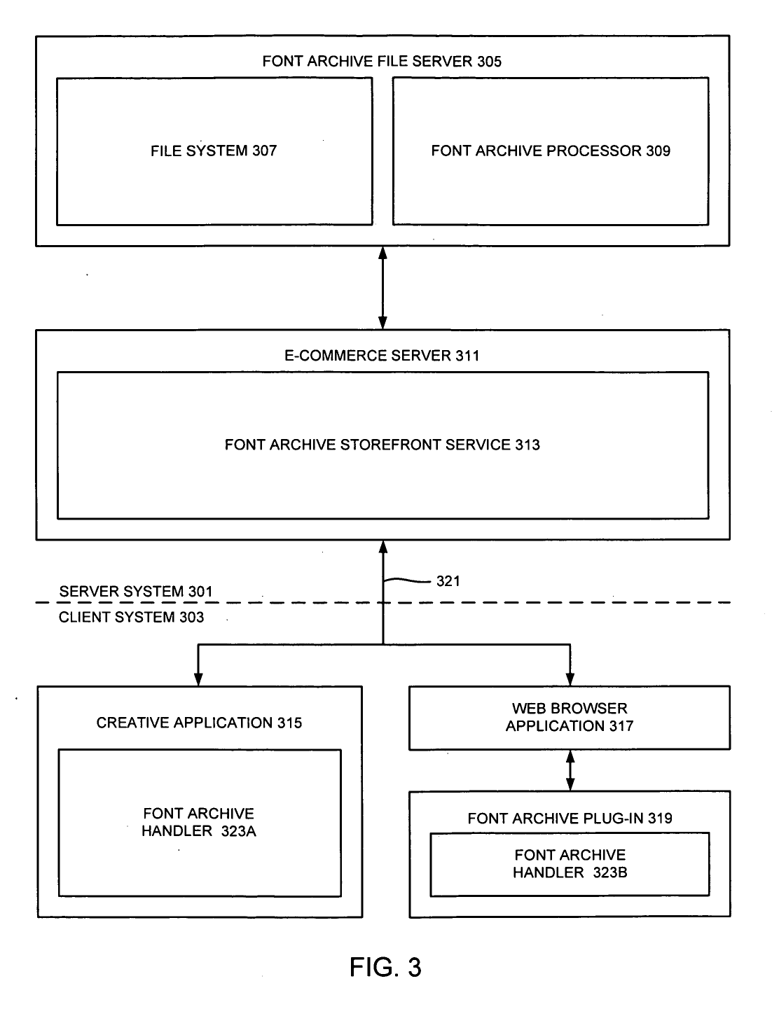

FIG. 3 illustrates components of a commerce system that can employ the font archive data structure 201 according to various examples of the invention. As seen in this figure, the commerce system includes a server system 301, and a client system 303. The server system 301 includes a font archive file server 305. The font archive file server 305 maintains one or more font archives, such as font archives using the font archive data structure 201, for distribution to a client system 303. The font archive file server 305 includes a file system 307 that stores the font archives. It also includes a font archive processor 309. The font archive processor 309 receives requests for one or more font archives from an e-commerce server 311. In response to an authorized request, the font archive processor 309 will transfer the requested font archives from the file system 307 to the e-commerce server 311.

The e-commerce server 311 then includes a font archive storefront service 313, which receives request for one or more font archives from the client system 303. As will be discussed in more detail below, the client system 303 may request a “licensed” or “unlicensed” font archive. If the client system 303 requests an “unlicensed” font archive, then the font archive storefront service 313 will provide the client system 303 with the requested font archive. If the client system 303 instead requests a “licensed” font archive, then the font archive storefront service 313 will engage in a purchase transaction for the font archive before providing the requested font archive to the client system 303. As will be appreciated by those of ordinary skill in the art, each of the font archive file server 305 and the e-commerce server 311 may be implemented on one or more computers, such as the computer 101 described above. Further, one or more functions of the font archive file server 305 and the e-commerce server 311 may be combined onto a single computer. The implementation and operation of the font archive file server 305 and the e-commerce server 311 may be conventional, and thus will not be described here in further detail.

Turning now to the client system 303, the client system 303 may host a creative application 315. The creative application 315 may be any type of software application executed on the client system 303 that will use fonts to, for example, create or view documents. As will be discussed in more detail below, the creative application 315 in the illustrated example is enabled to employ a font archive according to various examples of the invention (such as a font archive using the font archive data structure 201). Alternately or additionally, the client system 303 may host a Web browser application 317. The Web browser application 317 in turn will use a “plug-in” software application 319 that is enabled to employ a font archive according to various examples of the invention (such as a font archive using the font archive data structure 201). As will be appreciated by those of ordinary skill in the art, a plug-in software application is a small software application that “plugs in” to another software application to provide additional functionality. For example, many Web browser software applications will employ ActiveX or Java applet plug-ins.

Both the creative application 315 and the Web browser application 317 may communicate with the e-commerce server 311 using any desired communication channel 321, such as a channel using HTML. Thus, the use of a font archive on the client system 303 may be implemented either as an extension to a standard Web browser application, or as a special client application (e.g., a font management application). With various examples of the invention, both the creative application 315 and the Web browser application 317 will be capable of presenting a Web interface to the user. This behavior is assumed to be the same regardless of whether it is implemented in a standard web-browser plug-in or a dedicated application.

As shown in FIG. 3, both the creative application 315 and the font archive plug-in 319 include a font archive handler 323. As previously noted, the font archive handler 323 manages the use of font archives according to various embodiments of the invention on the client computer system 303. For example, the font archive handler 323 will be configured to decrypt each of the data segments making up the font archive. The font archive handler 323 also will analyze the metadata 205 in the font archive, to enforce the license policy for employing the font data 207. More particularly, the font archive handler 323 will determine the restrictions specified in the license policy for the font data 207. If the license policy allows for previewing of the font data 207, then the font archive handler 323 will decrypt the metadata 205 (and, if necessary, the font data 207) to implement the specified previewing technique. If the license policy allows for the actual use of the font data in one or more software applications, the font archive handler 323 will confirm that the operating environment and context of the client system 303 complies with any license restrictions before decrypting the font data 207.

The font archive handler 323 also insures that decrypted font data 207 is employed in-memory (i.e., only from the RAM or equivalent volatile memory) by the computer system 303. Typically, an operating system will provide two types of application programming interfaces (APIs) for activating font data for use on a computer. One type of API operates on font data stored on a non-volatile storage medium, such as a magnetic disk drive (such as a hard disk drive), an optical storage device (such as a CD or DVD), a flash memory card or the like. The other type of API operates on font data stored in-memory. By prohibiting the decrypted font data 207 from being stored on a non-volatile storage medium, the font archive handler 323 prevents unauthorized use of the font data 207 in violation of the license policy.

It should be noted that, while the font archive handler 323 is shown as being a part of the creative application 315 in FIG. 3, the font archive handler 323 may be separate from the creative application 315 in alternate examples of the invention. For example, the font archive handler 323 may be implemented as a plug-in or supplemental software application to the creative application 315. Also, as shown in FIG. 3, a font archive handler 323A for the creative application 315 may be different from a font archive handler 323B for the font archive plug-in 319. For example, the font archive handler 323A may have some distinctive functionality related to the intended use of the creative application 315, while the font archive handler 323B may have some distinctive functionality related to the operation of a Web browser communicating over a network, such as the Internet. It will be appreciated, however, that alternate implementations of the font archive handler 323 will share the functionality used to decrypt and manipulate font archives according to various embodiments of the invention.

Browsing and Purchase of a Font

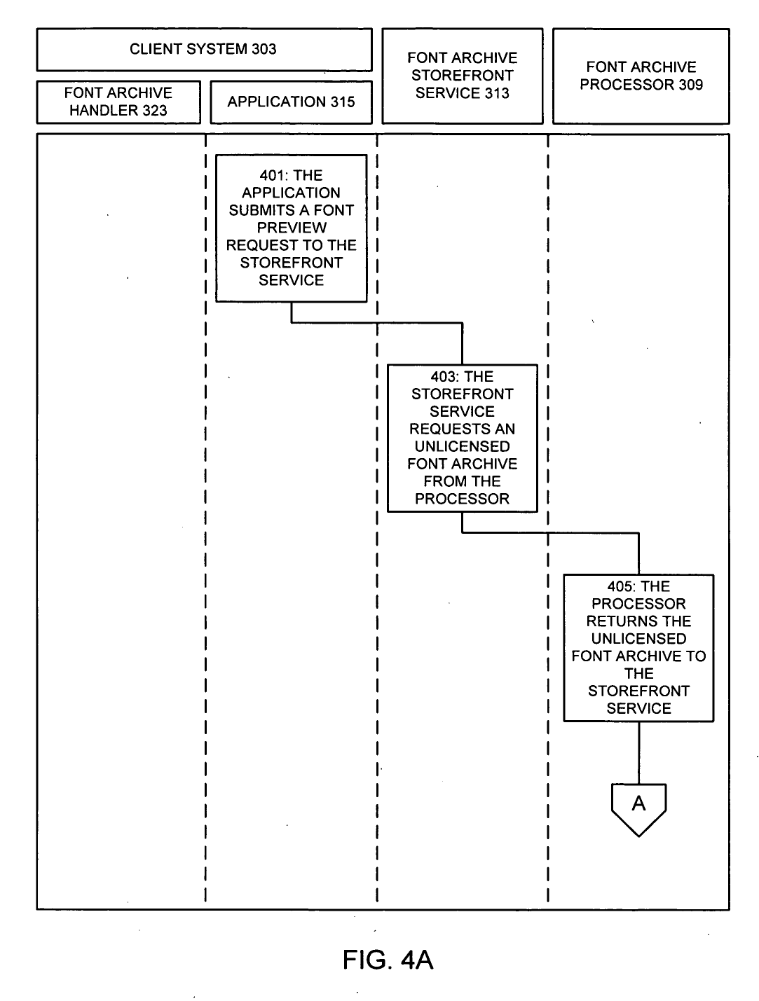

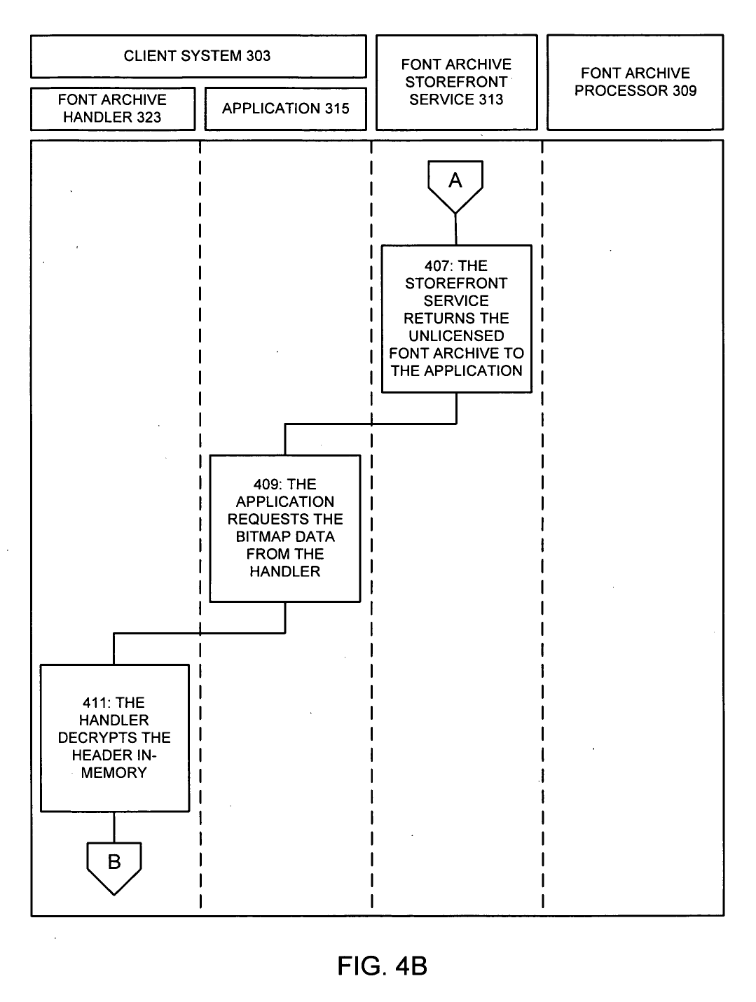

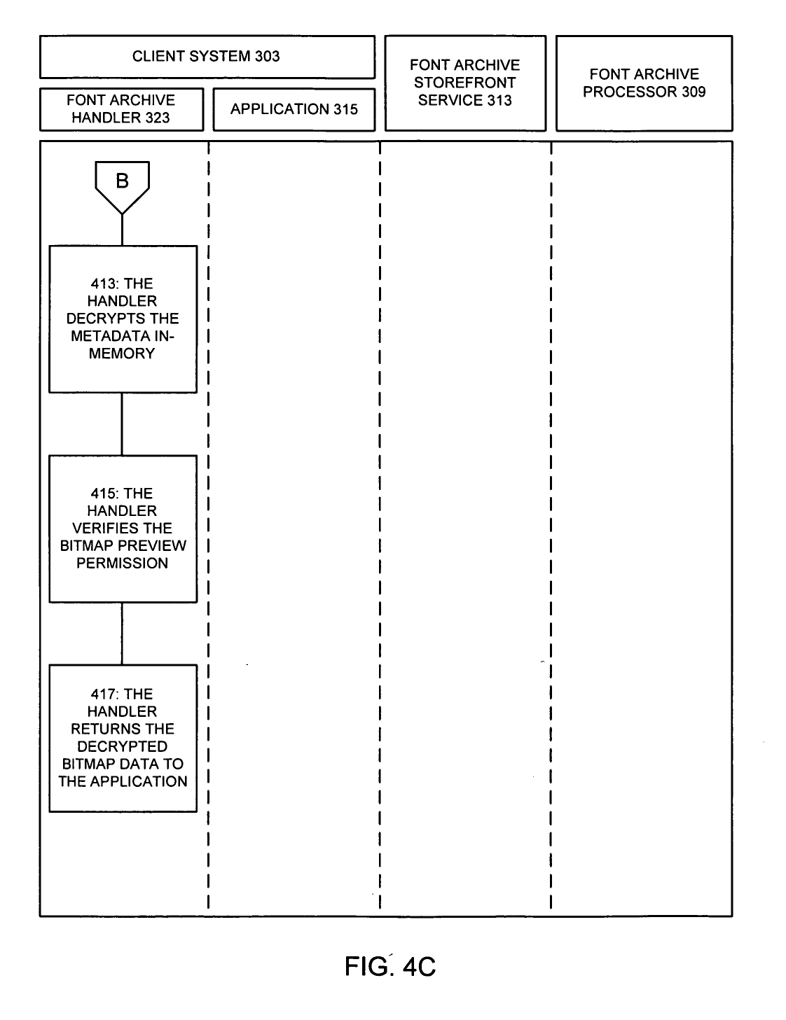

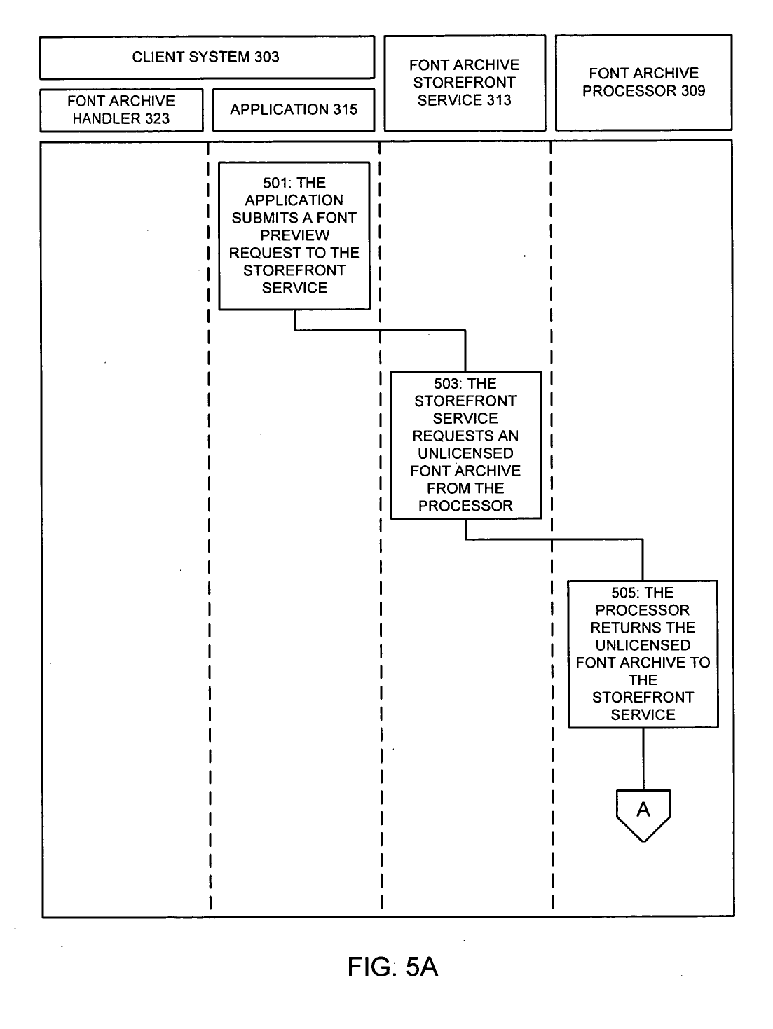

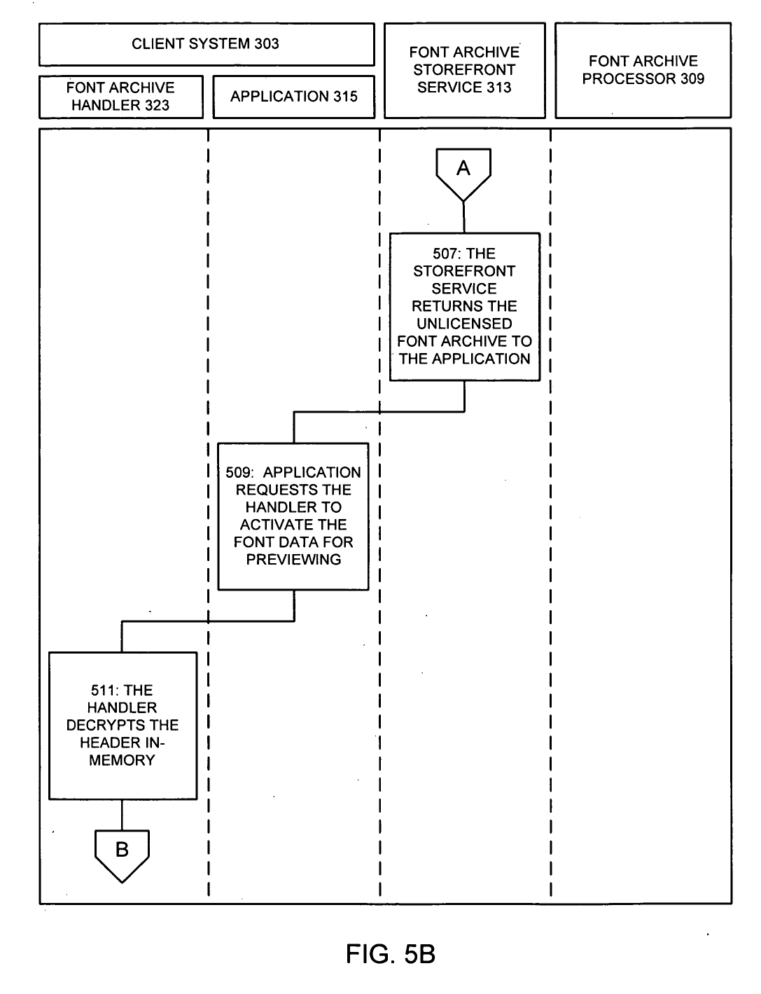

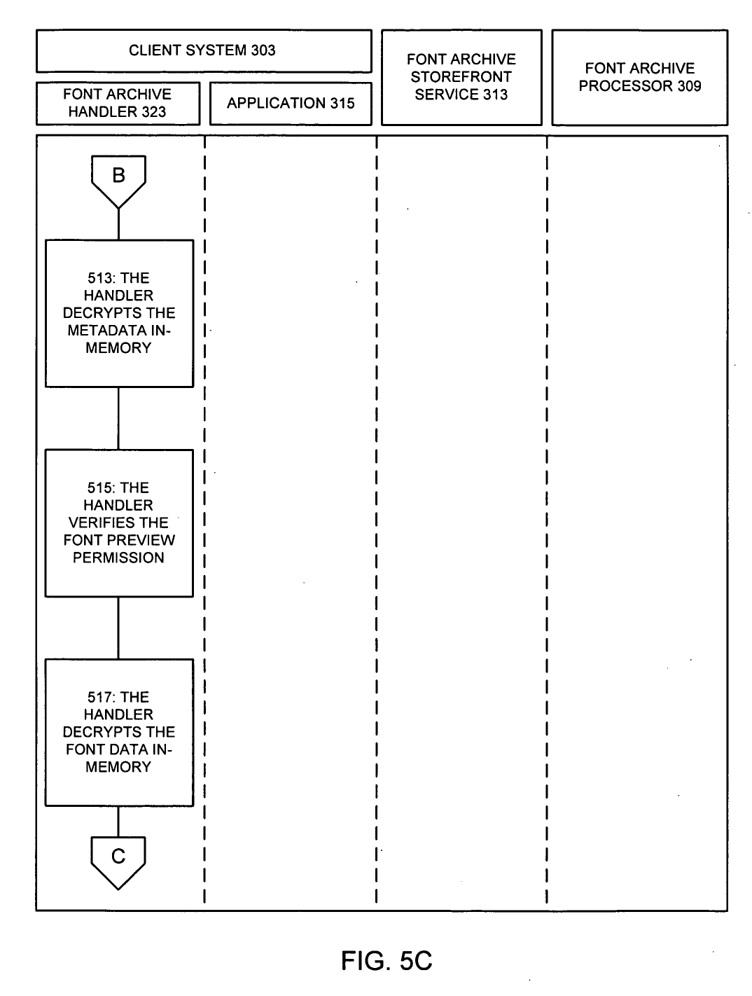

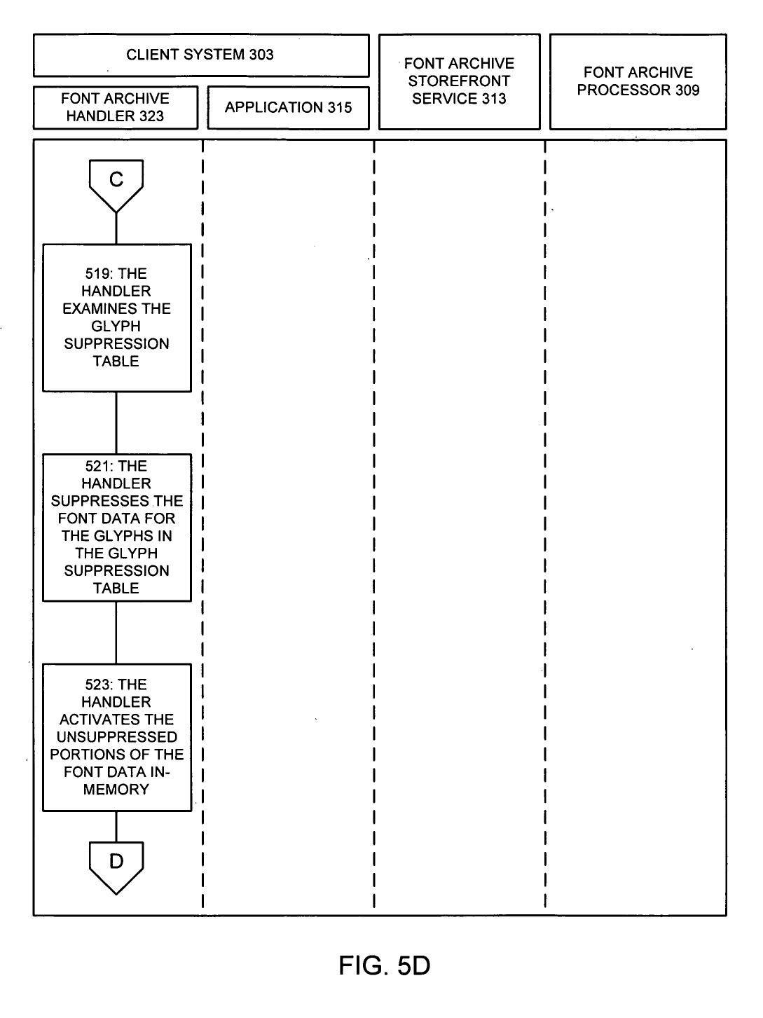

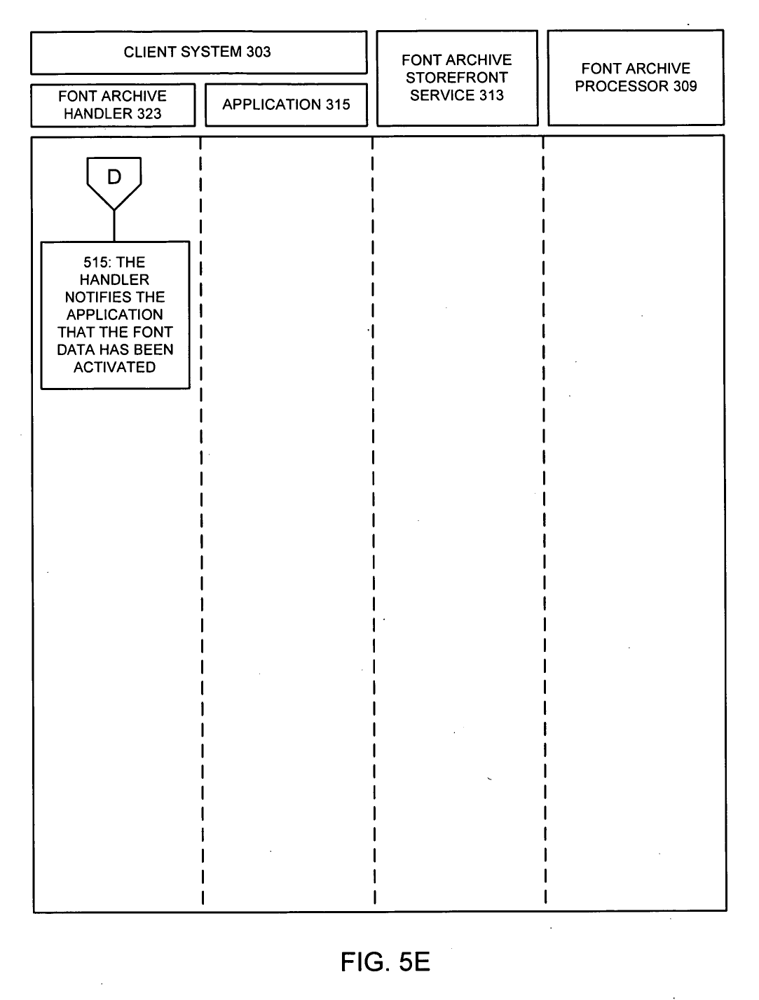

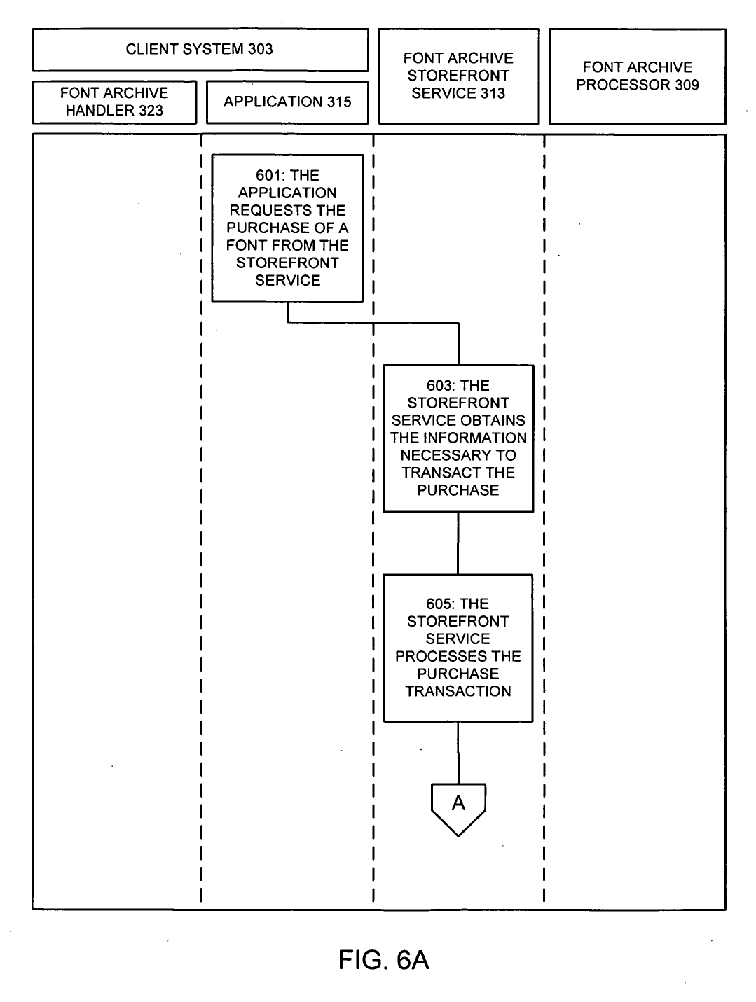

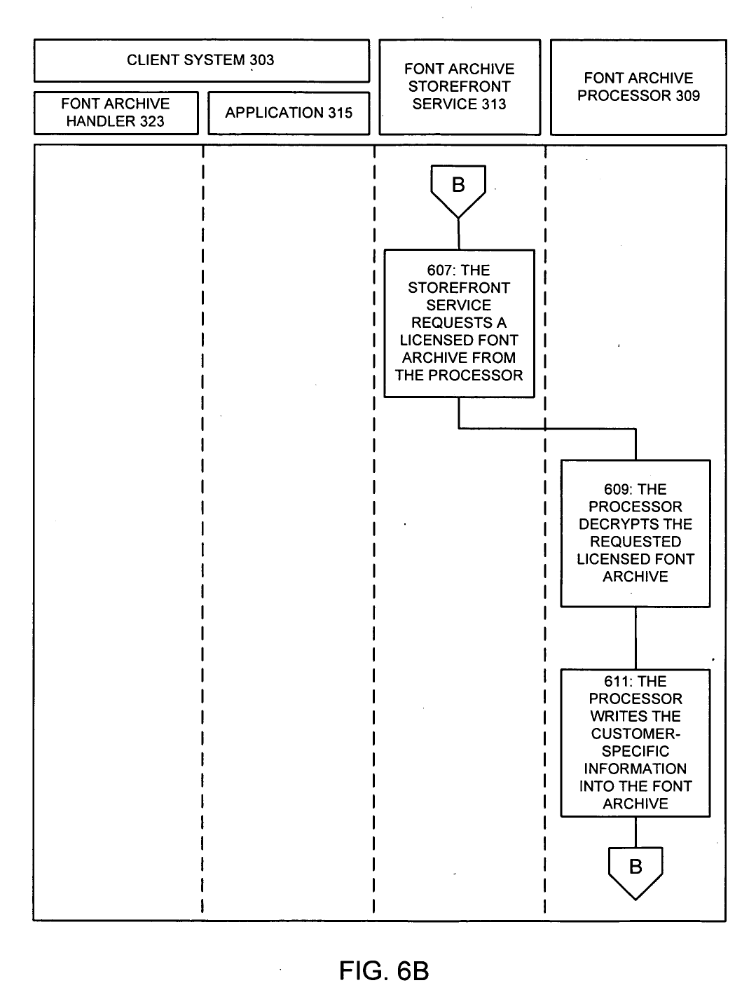

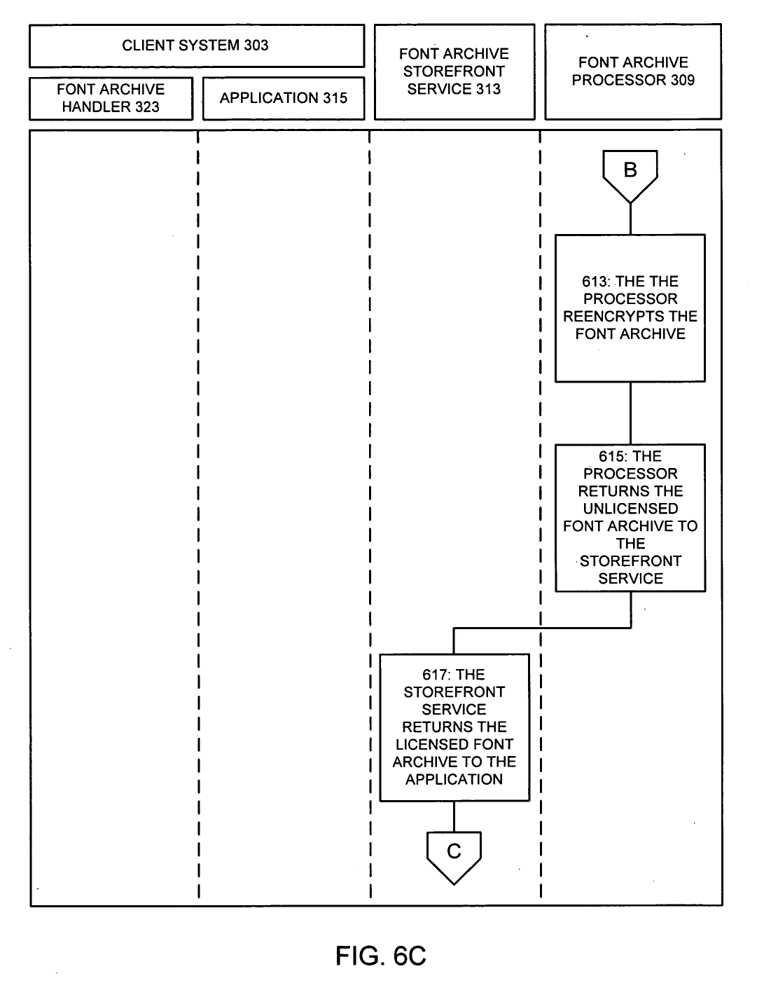

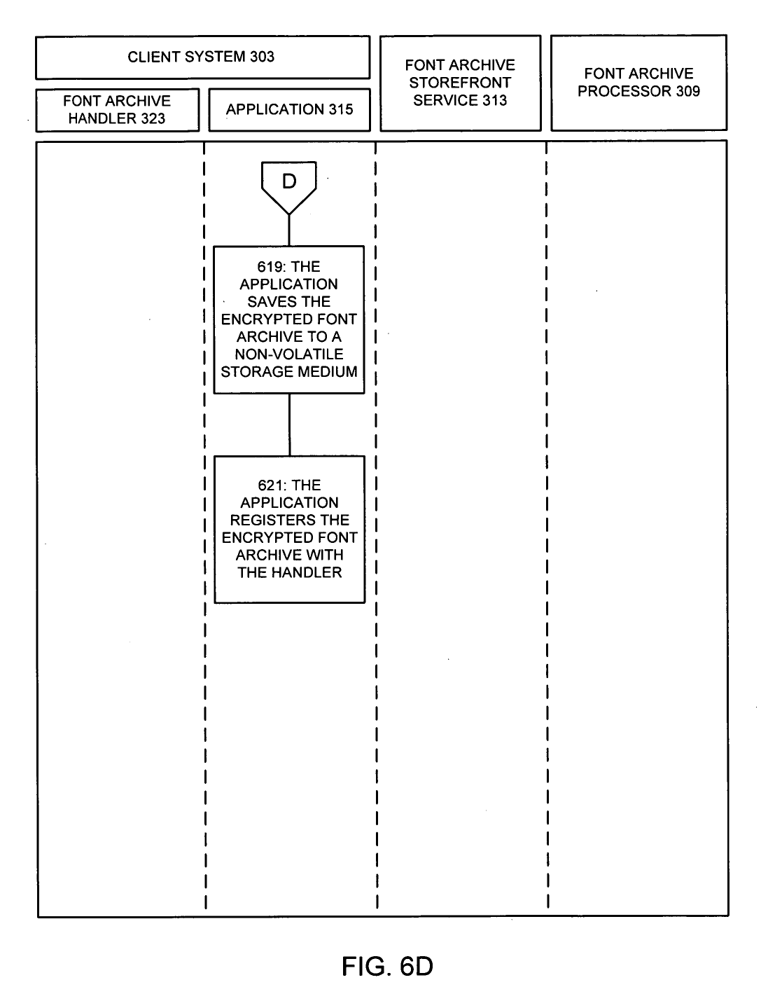

FIGS. 4-6 illustrate processes for browsing a font prior to purchasing font data 207 for the font, and for purchasing licensed font data 207. More particularly, FIGS. 4A-4C illustrate a flowchart describing a method of previewing bitmaps for a font according to various embodiments of the invention. FIGS. 5A-5E then illustrate a flowchart describing a method of previewing select glyphs of a font according to various embodiments of the invention, while FIGS. 6A-6D illustrate a flowchart describing a method of purchasing licensed font data according to various embodiments of the invention.

It should be noted that FIGS. 4A-6D illustrate the described methods with reference to the font archive-enabled application 315. It should be noted, however, that these methods also are applicable to client systems 303 hosting a Web browser application 317 using a font archive plug-in 319. Also, in these figures, the font archive handler 323 is described as a separate entity from the creative application 315 in order to provide a better understanding of the various aspects and features of the invention. Accordingly, as used in discussing FIGS. 4A-8, the references to the creative application 315 indicate the functionality of the creative application that are separate from the functionality of the font archive handler 323.

Turning now to FIGS. 4A-4C, in step 401, the creative application 315 (or a user employing the font archive-enabled application 315) submits a request to the font archive storefront service 313 to preview a font. In response, the font archive storefront service 313 requests an unlicensed font archive from the font archive processor 309 in step 403. Next, in step 405, the font archive processor 309 returns an unlicensed font archive to the font archive storefront service 313. Thus, if the font archive is using the font archive data structure 201, then the metadata 205 will include a license policy 221 having a value of “demo,” “bitmap only,” or “glyph-suppressed,” as described in detail above. Because the method illustrated in FIGS. 4A-4C is for previewing bitmaps of a font, then the license policy 221 will have the value of “bitmap only.” Further, the demo/preview data 233 in the metadata 205 will include bitmap data corresponding to the font data 205, as noted above. Then in step 407, the font archive storefront service 313 returns the unlicensed font archive to the font archive-enabled application 315.

In step 409, the creative application 315 requests the bitmap data from the font archive handler 323. In response, the font archive handler 323 decrypts the header 203 in-memory in step 411. Then, in step 413, the font archive handler 323 decrypts the metadata 205 in-memory. By decrypting the metadata 205, the font archive handler 323 decrypts both the bitmap data included in the demo/preview data 233 and the license policy 221. In step 415, the font archive handler 323 verifies the bitmap preview permission by, e.g., confirming that the value of the license policy 221 allows for viewing of the bitmap data. Once the font archive handler 323 has verified the bitmap preview permission, it returns the decrypted bitmap data to the creative application 315 in step 417. The creative application 315 may then present the bitmap data to a user as desired, such as by rendering the described bitmaps on a display or by printing the described bitmaps onto paper. In this manner, a user can preview a font without having to purchase a license for the font data 207 defining the font. Further, because the bitmap data is decrypted and kept in-memory on the client system 303, the bitmap data cannot be misappropriated for unauthorized use.

As previously noted, FIGS. 5A-5E illustrate a flowchart describing a method of previewing select glyphs of a font according to various embodiments of the invention. In step 501, the creative application 315 (or a user employing the font archive-enabled application 315) submits a request to the font archive storefront service 313 to preview a font. In response, the font archive storefront service 313 requests an unlicensed font archive from the font archive processor 309 in step 503. Next, in step 505, the font archive processor 309 returns an unlicensed font archive to the font archive storefront service 313. Because the method illustrated in FIGS. 5A-5E is for previewing only representative glyphs of a font, then the license policy 221 will have the value of “demo” or “glyph-suppressed.” Further, if the value of the license policy 221 is “glyph-suppressed,” then the demo/preview data 233 in the metadata 205 will include a glyph suppression table that identifies one or more glyphs in the font data 207 that should not be rendered until after the font data 207 has been properly licensed, as noted above. Then in step 507, the font archive storefront service 313 returns the unlicensed font archive to the font archive-enabled application 315.

In step 509, the creative application 315 requests the font archive handler 323 to activate the font data for previewing. In response, the font archive handler 323 decrypts the header 203 in-memory in step 511. Then, in step 513, the font archive handler 323 decrypts the metadata 205 in-memory. By decrypting the metadata 205, the font archive handler 323 decrypts both the license policy 221 and, if applicable, the glyph suppression table included in the demo/preview data 233. In step 515, the font archive handler 323 verifies the font preview permission by, e.g., confirming that the value of the license policy 221 allows for previewing of either all of the font data or selected glyphs in the font data. Once the font archive handler 323 has verified the font preview permission, it decrypts the font data 207 in-memory in step 517.

If the license policy 221 allows for previewing only selected glyphs in the font data, then in step 519 the font archive handler 323 examines the glyph suppression table decrypted from the metadata 205. In step 521, it then suppresses the portions of the font data 207 describing the glyphs identified in the glyph suppression table. Next, in step 523, the font archive handler 323 activates the unsuppressed portions of the font data 207 in-memory. If the license policy 221 allows for previewing all of the glyphs in the font data, then the process proceeds immediately from step 517 to step 523, and no portion of the font data 523 will be suppressed (i.e., all of the font data will be activated in-memory). With some examples of the invention, the font archive handler 323 may only activate the font data in-memory specifically for use by the font archive-enabled application 315.

In step 525, the font archive handler 323 notifies the creative application 315 that the font data 207 has been activated. The creative application 315 may then present the font data to a user as desired, such as by rendering the defined fonts on a display or by printing the defined fonts onto paper. In this manner, a user can preview a font without having to purchase a license for the font data 207 defining the font. Again, because the font data 207 is decrypted and kept in-memory on the client system 303, the font data 207cannot be misappropriated for unauthorized use.

Thus, font archives according to various embodiments of the invention (such as font archives using a data structure like, e.g., the font archive data structure 201) permits previewing of unlicensed fonts on a client. The client system 303 downloads the encrypted font archive, and then manipulates its contents in-memory. As described above, the font archive handler 323 may extract preview bitmaps from the metadata 205 portion of the font archive. Alternately, the font archive handler 323 may privately activate the font data 207 in memory for the creative application 315 to render scalable screen-resolution previews, possibly with selected glyph suppression. Of course, various examples of the invention may employ an alternative browsing process, by which the file server 303 can simply present static bitmaps and metadata directly in an online catalog without ever accessing or transferring the font archive data structure 201 to the client system 307, until the font data 207 is purchased.

It also should be appreciated that some embodiments of the invention may allow a user to preview either bitmaps or decrypted font data. That is, with some embodiments of the invention, the font archive may specify a licensing policy that permits a user to preview both bitmaps and decrypted font data 207. For example, if a font archive is using the font archive data structure 201, then the license policy 221 may have a value of “bitmap” rather than “bitmap only” (i.e., a value not exclusively limited to bitmap previewing). The license policy 221 may then have a second value of, e.g., “glyph-suppressed.” With these embodiments, the user of the creative application 315 (or the Web browser application 317) may be allowed to choose which type of data will be used to preview the fonts. Alternately, the creative application 315 (or the Web browser application 317) may automatically choose between the preview data types based upon some preset criteria, as desired. It should further be noted that the creative application 315 (or the Web browser application 317) may impose other restrictions on the use of the font data 207, such as disabling of high-resolution printing. These restrictions may be implemented through, for example, the font archive handler 323.

Referring now to FIG. 6, this figure illustrates a flowchart describing a method for purchasing font data according to various examples of the invention, as previously noted. As seen in this figure, in step 601 the creative application 315 requests the purchase of a font from the font archive storefront service 313. With some examples of the invention, the creative application 315 may automatically detect the need for a font, and then request the font from the font archive storefront service 313. Alternately, a user may determine a need for a font and instruct the creative application 315 to request the font from the font archive storefront service 313.

Next, in step 603, the font archive storefront service 313 obtains the information necessary to transact the purchase through the creative application 315. For example, the font archive storefront service 313 may obtain payment information, such as credit card information or online payment service account information. The font archive storefront service 313 may also obtain the license terms desired by the creative application 315 (or the user controlling the creative application 315) under which the font may be used. Then, in step 605, the font archive storefront service 313 processes the purchase transaction. For example, the font archive storefront service 313 may verify that the purchase is legitimate, that the payment information provided by the creative application 315 is accurate, generate an identification number for the transaction, notify the creative application 315 that a successful purchase transaction is in progress, etc.

In step 607, the font archive storefront service 313 requests a licensed font archive from the font archive processor 309. In addition to specifying the desired font, the request typically also will include customer information and the licensing terms sought by the user of the creative application 315. That is, any customer-specific information that will be included in the font archive typically will be transmitted with the request for the licensed font archive. In response, the font archive processor 309 will decrypt the requested font archive in step 609.

For example, the font archive processor 309 obtains a font archive with the requested font from the file system 307, and then decrypts the font archive in-memory (i.e., on the RAM or other volatile memory) on the font archive file server 305. Next, in step 611, the font archive processor 309 writes the customer-specific information into the decrypted font archive. For example, if the user requested specific license terms, then these terms will be written into the decrypted font archive. Once the customer-specific information has been written into the font archive, the font archive processor 309 reencrypts the (now-licensed) font archive in step 613. The font archive processor 309 then returns the licensed font archive to the font archive storefront service 313 in step 615. Similarly, the font archive storefront service 313 returns the licensed font archive to the creative application 315 in step 617.

In step. 619, the creative application 315 saves the encrypted font archive to a non-volatile storage medium, such as a hard disk drive. It then registers the encrypted font archive with the font archive handler 323 in step 621. Thus, the creative application 315 (or, with alternate implementations of the invention, the Web browser application 317) can secure obtain a customer-specific font archive with desired license terms.

Activation of a Font

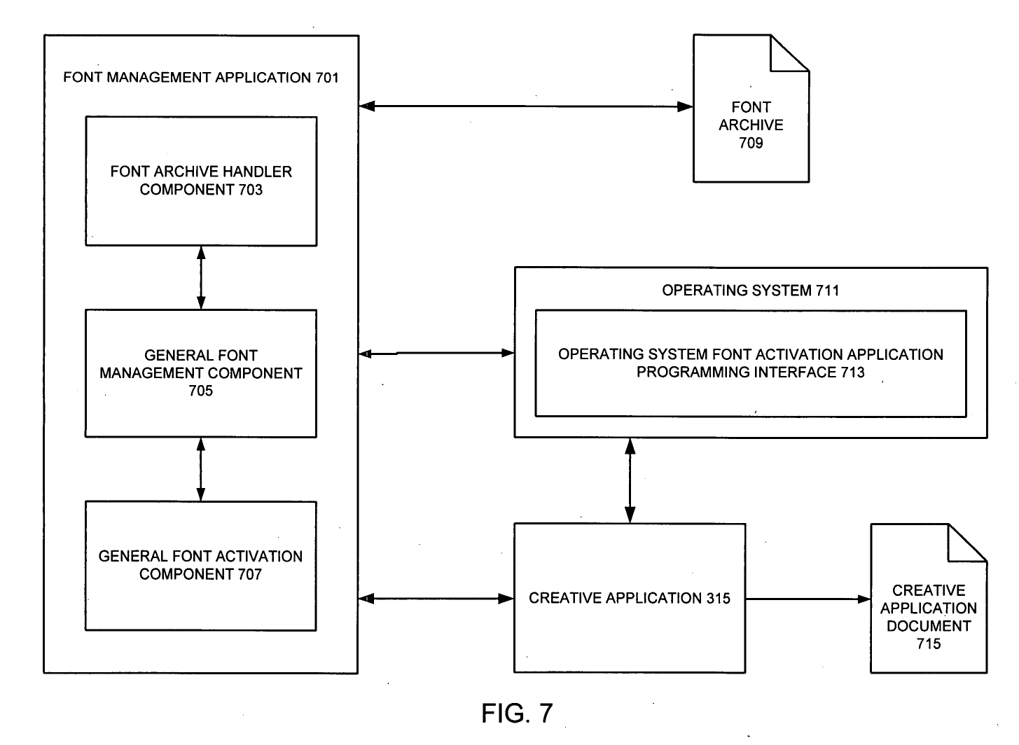

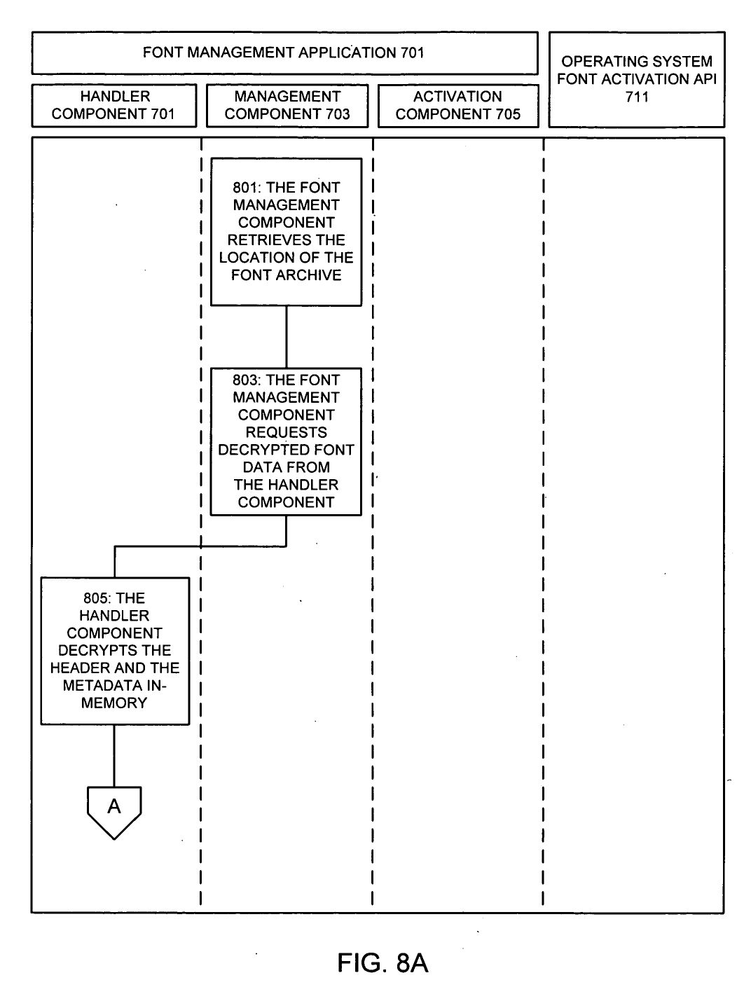

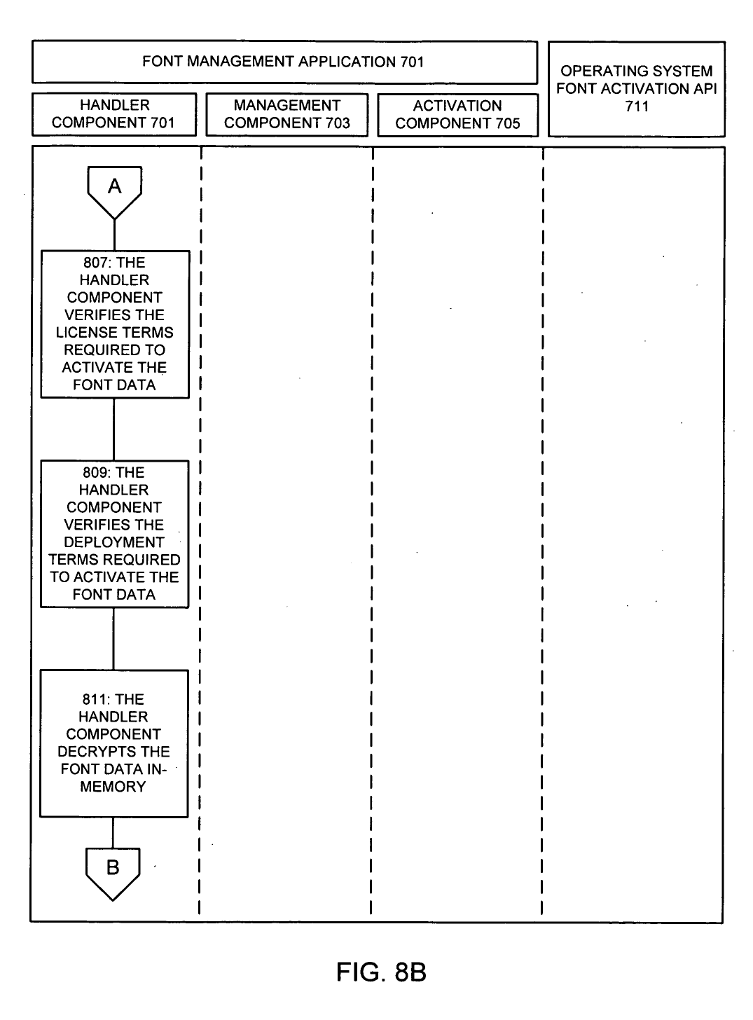

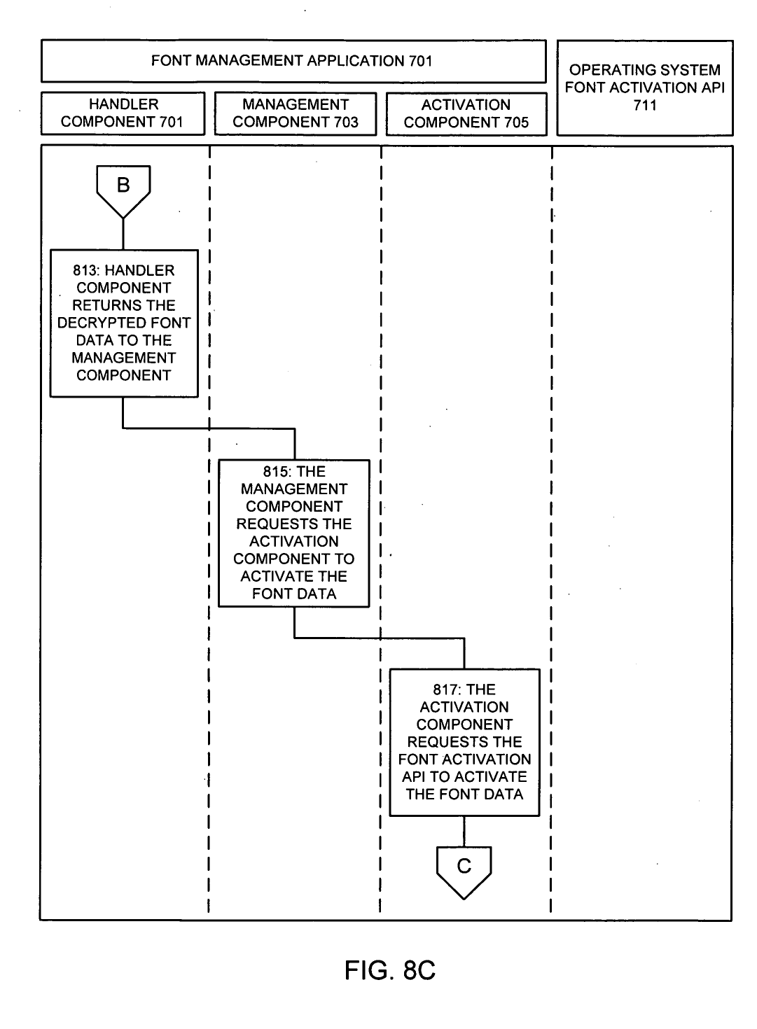

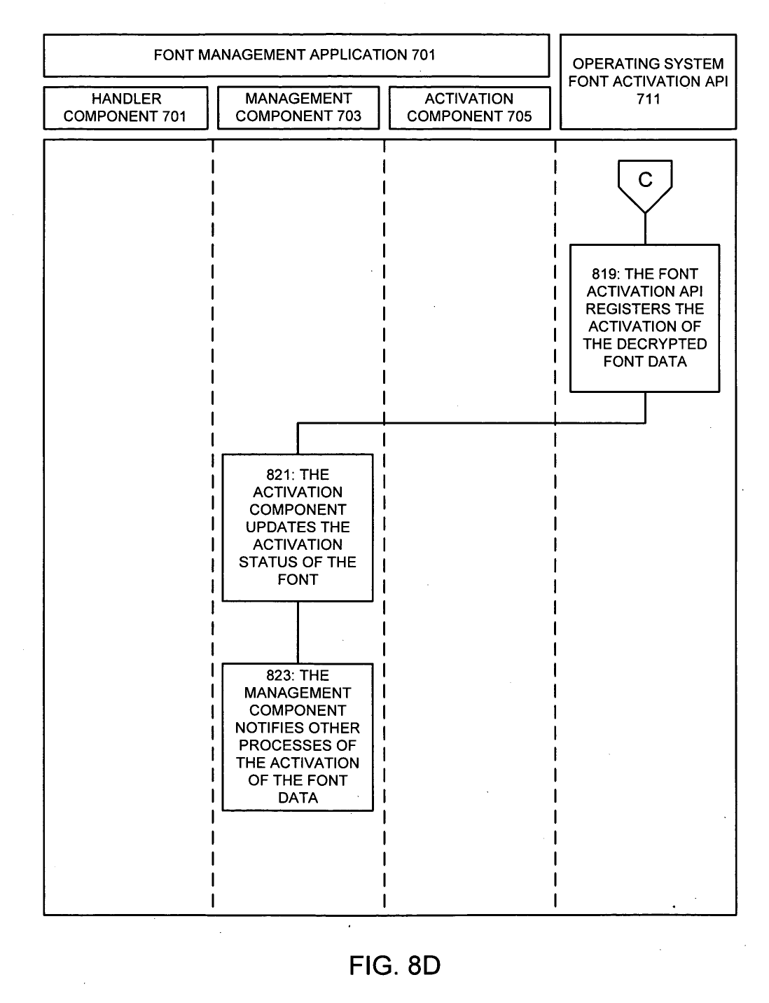

FIGS. 7 and 8 relate to the activation of font data 207 from a font archive according to various examples of the invention. In particular, FIG. 7 illustrates the components of client system 303 that will activate and use font data 207. FIGS. 8A-8D then illustrate a flowchart describing a process for activating font data.207 in a font archive according to various embodiments of the invention.

Turning now to FIG. 7, the client system includes a font management application 701. The font management application 701 figure shows the font archive handler 323 in more detail. In particular, the font archive handler 323 includes a font archive handler component 703, a general font management component 705, and a general font activation component 707. The font management application 701 communicates with a font archive 709 according to various examples of the invention that is stored in the client system 303. As previously noted, the font archive 709 will typically be stored in an encrypted state on a non-volatile storage medium, such as a hard disk drive. The font management application 701 also communicates with the operating system 711 of the client system 309. As shown in FIG. 7, the operating system 711 includes an operating system font activation application programming interface (API) 713. Both the font management application 701 and the operating system 711 communicate with the creative application 315, which in turn may create, edit and/or view a creative application document 715.

With regard to the font management application 701, the font archive handler component 703 performs the same functions as the font archive handler 323 discussed in detail above. Thus, the font archive handler component 703 decrypts each of the data segments making up the font archive. As will be discussed below, the font archive handler component 703 also is responsible for analyzing the metadata 205 in the font archive, to enforce the license policy for employing the font data 207. For example, the font archive handler component 703 will determine the restrictions specified in the license policy for the font data 207, and insure that decrypted font data 207 is employed in-memory (i.e., only from the RAM or equivalent volatile memory) by the computer system 303. With some embodiments of the invention, the font archive handler component 703 may be the same application as the font archive handler 323 used by the creative application 315 or the Web browser application 317. With still other examples of the invention, however, the font archive handler component 703 may be separate from the font archive handler 323 used by the creative application 315 and the Web browser application 317.

The general font management component 705 manages the process of activating the font data 207 in the font archive 709. For example, the general font management component 705 will retrieve the location of the font archive 709 specified for the activation process, and provide the decrypted font date 207 to the general font activation component 707 for activation. With some examples of the invention, the general font management component 705 may be, for example, a conventional font management software application. Like the general font management component 705, some examples of the invention, the general font activation component 707 also may be, for example, a conventional font activation software application. The general font activation component 707 then activates the decrypted font data. For example, the general font activation component 707 will request that the operating system font activation API 713 activate the decrypted font data 207 and make it available for use by software applications and/or in operating environments specified by the font archive handler component 703 (based upon the license information contained in the metadata 207).

The operating system font activation API 713 operates on font data stored in-memory. Using the decrypted font data 207 from RAM rather than a non-volatile storage medium prevents unauthorized use of the font data 207 in violation of the license policy. It should be noted that, while the general font management component 705 and the general font activation component 707 are illustrated as components of the font management application 701 in FIG. 7, alternate embodiments of the invention may implement one or both of these components as separate software applications used in conjunction with the font archive handler component 703.

Referring now to FIGS. 8A-8D, in step 801 the general font management component 705 retrieves the location of the font archive 709 requested through the creative application 315 (or the Web browser application 317). Next, in step 803, the general font management component 705 requests the font archive handler component 703 to provide decrypted font data 207. Using the obtained location of the font archive 709, in step 805 the font archive handler component 703 then decrypts the header 203 and the metadata 205 in-memory.

Once the font archive handler component 703 has decrypted the header 203 and the metadata 205 in-memory, it verifies that the license terms for the font data 207 will allow the font data to be activated. In step 809, the font archive handler component 703 also verifies that the local context (e.g., the operating environment of the client system 303) complies with any deployments terms that must be met to activate the font data 207. As discussed in detail above, the license and deployment terms for using the font data 207 are contained in the metadata 205. Next, in step 811, the font archive handler component 703 decrypts the font data 207 in-memory. The font archive handler component 703 subsequently returns the decrypted font data 207 to the general font management component 705 in step 813.

In step 815, the general font management component 705 requests that the general font activation component 707 activate the decrypted font data 207. The general font activation component 707 then requests the operating system font activation API 713 to activate the decrypted font data 207 in step 817, and provides any applicable license and deployment terms associated with the font data 207. The operating system font activation API 713 registers the activation of the decrypted font data 207 in step 819, and the general font activation component 707 updates the activation status of the font in step 821. Lastly, in step 823, the general font management component 705 notifies other processes, such as the creative application 315, of the activation of the font data 207.

As noted above, any copy of a font archive according to embodiments of the invention that is saved to a non-volatile storage device, such as a hard disk drive, will be encrypted. Thus, it will not be usable except via an authorized instantiation of the font archive handler component 703 (or the font archive handler 323) that has the necessary decryption information to decrypt the font archive.

The initiation of this activation sequence can come from a variety of sources. For example, a user could explicitly request the activation of font data in an available font archive data in a font browser interface of the general font management component 705. Alternately, a creative application 315 could generically request a font which is only available on the client system 303 through a font archive according to various examples of the invention, with the request coming to the general font management component 705 as a standard font request. The general font management component 705 could communicate directly with a creative application 315 via, for example, a plug-in.

These modes of activation are familiar alternatives in current font management products and as such are not described here in detail. However, it will be apparent from the foregoing description that advanced features of the activation process will be particular to certain modes of the activation request. For example, if the font data 207 is being licensed with document-specific and/or application-specific deployment permissions, then the request to activate the font data will typically originate in a plug-in to the relevant creative application 315 (or Web browser application 31 7). Further, the activation of the font data 207 will then be made private to the creative application 315 rather than being available globally to the operating system 711 of the client system 303.

Many of the same features of font archives according to various embodiments of the invention that facilitate online purchasing and validated local use of fonts also can be used to facilitate secure, licensed font rendering in delivery of online Web content, as noted above. As previously noted, this type of implementation would employ a web browser plug-in containing an embedded font archive handler 323 capable of decrypting and securely caching fonts and enforcing deployment and license terms. The plug-in will only activate fonts privately for the Web browser application 317. The Web-deployment implementation and use of font archives according to various embodiments of the invention does not require any special process or configuration on the Web server. Instead, font archives for Web-licensed font data 207 may be stored like any file on a Web server, and included in a Web document via the standard HTML <EMBED> tag.

Like other embedded font technologies, use of font archives according to various embodiments of the invention permits the possibility that an end-user may view the source of a Web page, discover the location of the font archive, and download this archive to a local machine. Unlike conventional font technologies, however, the features of the font archives according to invention ensure that the font data 207 will not be usable when downloaded to a new location. The license and deployment restrictions embedded within a font archive will preclude its activation from any authorized font management application 701 or font archive handler 323. Further, the use of strong encryption for the font data 207 within the font archive will prevent it from being used by other font activation means. Only documents loaded in a Web browser and served from Internet locations indicated in the font archive data structure 201 deployment dictionary will be capable of being rendered by the browser with the privately activated font.

As discussed in detail above, activation of font data 207 within a font archive stored on a local machine or intranet typically will require the presence of a font management application 701 on the client machine. As also noted, the scope of the activation depends on license and deployment data in the font archive. It also should be noted, however, that the scope of the activation also may depend upon the implementation of the font management application 701. For example, the font management application 701 may be implemented as standalone application on a local computer. Alternately, it may be implemented as a networked application that shares font archives for group-licensed font data 207 with multiple users in, for example, an intranet.

If a distributed environment is used to manage fonts (where for example, all font archives are maintained on a central network server accessible by font management applications operating on client computers in the network), the licensing data stored in the font archives can be used by an authorized server process to track and control the use of the font data 207, to ensure that each use of the font data 207 complies with its licensing terms. Font archives that contain font data 207 specifically licensed for a single local computer (via the deployment restriction features discussed in detail above) thus will not be usable on other computers in the network, even if the font archives are shared on a network volume or via a central server. The local activation process implemented by the font management application 701 on a particular client computer will honor the license terms specified in the font archive, regardless of contrary server instructions. As will be appreciated by those of ordinary skill in the art, the use of font archives in a network, with instances of the font management application 701 on client computers, can be implemented simply as an extension of local-machine use of font archives that will still go through local-machine license validation and activation processes.

Conclusion

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A font archive, comprising:
encrypted font data; and
metadata containing information associated with the font data.

2. The font archive recited in claim 1, wherein the metadata is encrypted,

3. The font archive recited in claim 1, wherein the metadata includes preview information for previewing a font defined by the font data.

4. The font archive recited in claim 3, wherein the preview information is bitmap information describing the requested font.

5. The font archive recited in claim 3, wherein the preview information identifies glyphs in the requested font that cannot be previewed.

6. The font archive recited in claim 1, wherein the metadata includes information specific to a purchaser of the font data.

7. The font archive recited in claim 1, wherein the metadata includes license information related to a license of the font data.

8. The font archive recited in claim 7, wherein the license information includes terms under which the font data may be used.

9. The font archive recited in claim 1, further comprising a header containing information associated with the font data and the metadata.

10. A computer system for employing a font archive, comprising a processing unit implementing:
a software application requesting use of a font; and
a font archive handler that
obtains a font archive containing
encrypted font data defining the requested font, and
metadata containing information associated with the font data, and
decrypts the font data based upon the metadata.

11. The computer system recited in claim 10, wherein
the metadata includes bitmap information representing the requested font, and
the font archive handler
does not decrypt the font data, and
provides the bitmap information to the software application.

12. The apparatus recited in claim 10, wherein
the metadata includes permission to preview at least a portion of a plurality glyphs included in the requested font, and
the font archive handler
decrypts the font data, and
provides at least a portion of the font data defining the at least a portion of the
plurality of glyphs to the software application.

13. The apparatus recited in claim 12, wherein the metadata includes glyph exclusion information identifying one or more glyphs in the plurality of glyphs that cannot be provided to the software application.

14. The computer system recited in claim 10, wherein
the metadata includes license information defining license terms under which the representing the requested font, and
the font archive handler
verifies that the execution of the software application complies with the license terms, and
decrypts the font data, and
provides the decrypted font data to the software application.

15. A computer system for activating a font archive, comprising a processing unit implementing:
a software application requesting activation of a font;
an operating system font activation application programming interface that activates font data; and
a font management application that
obtains a font archive containing
encrypted font data defining the requested font, and
metadata containing license information associated with the font data, and
determines if the execution of the software information complies with the license information,
if the execution of the software information complies with the license information, decrypts the font data, and
provides the decrypted font data to the operating system font activation application programming interface for activation.

16. The computer system recited in claim 15, wherein the font management application provides at least a portion of the license information to the operating system font activation application programming interface to control use of the font data subsequent to activation of the font data.

17. A method of previewing a font, comprising
receiving a request from a software application to preview a font;
obtaining a font archive that contains
encrypted font data defining the requested font, and
metadata associated with the font data;
determining if the metadata includes preview information; and
providing the font data to the software application based upon the preview information.

18. The method recited in claim 17, wherein the preview information contains bitmap information describing the font; and
further comprising providing the bitmap information to the software application.

19. The method recited in claim 18, wherein the preview information identifies one or more glyphs in the font that are restricted from previewing; and
further comprising
decrypting the font data,
determining a portion of the decrypted font data that defines glyphs in the font that are not identified in the metadata as restricted from previewing, and
providing the portion of the decrypted font data to the software application for previewing.

20. A method of activating a font, comprising:
receiving a request from a software application to use a font;
obtaining a font archive that contains
encrypted font data defining the requested font, and
metadata associated with the font data;
determining if the metadata includes license information for the font data; and
providing the font data to the software application based upon the license information.

22. The method of activating a font recited in claim 20, wherein
the license information includes terms under which the font data may be used, and
further comprising
determining if execution of the software application complies with the terms under which the font data may be used, and
if execution of the software application complies with the terms under which the font data may be used, then
decrypting the font data, and
requesting activation of the decrypted font data.
